(19) United States
(12) Patent Application Publication
(10) Pub. No.: US 2026/0285080 A1
(43) Pub. Date: Sep. 24, 2026

(54) LAYOUT TOOL

(71) Applicant: JessEm Tool Corporation, Moncton (CA)

(72) Inventors: Justin Perdu, Moncton (CA); Adam Vincent, Moncton (CA)

(21) Appl. No.: 19/086,694

(22) Filed: Mar. 21, 2025

(51) Int. Cl. B43L 7/02; B43L 7/14; G01B 3/04

(52) U.S. Cl. CPC B43L 7/02; B43L 7/14; G01B 3/04

(57) ABSTRACT

A layout tool is provided for use in marking a workpiece. The layout tool has a generally flat body with a face and a linear edge. The face is arranged to rest on a surface of the workpiece. A base is coupled to the flat body. A stabilizer is supported by the base. The stabilizer is moveable relative to the base between a first position where the stabilizer is arranged to engage the surface of the workpiece when the face of the flat body rests on the surface of the workpiece and a second position.

### FIELD

The present disclosure generally relates to a layout tool for a workpiece and more particularly to a layout tool with one or more stabilizers for supporting the tool on the workpiece.

### BACKGROUND

Layout tools, such as rulers and squares (e.g., T-shaped squares, L-shaped squares, triangle squares, etc.), are commonly used as a measuring, cutting and/or drawing tool as a reference and markup guide for marking up a workpiece.

### SUMMARY

In one aspect, a layout tool for use in marking a workpiece comprises a generally flat body having a face and a linear edge. The face is arranged to rest on a surface of the workpiece. A base is coupled to the flat body. A stabilizer is supported by the base. The stabilizer is moveable relative to the base between a first position where the stabilizer is arranged to engage the surface of the workpiece when the face of the flat body rests on the surface of the workpiece and a second position.

Other objects and features will be in part apparent and in part pointed out hereinafter.

### BRIEF DESCRIPTION OF THE DRAWINGS

FIG. 1 is a top perspective of a layout tool according to one embodiment of the present disclosure, stabilizers of the layout tool being in a retracted position;

FIG. 2 is a bottom perspective thereof;

FIG. 3 is an enlarged, fragmentary top perspective of layout tool with the stabilizers of the layout tool in a deployed position;

FIG. 4 is an enlarged, fragmentary elevation of the layout tool with the stabilizers in the deployed position;

FIG. 5 is an enlarged, fragmentary perspective of the layout tool with components hidden from view to show interior details, the stabilizers being in the retracted position;

FIG. 6 is similar to FIG. 5, except the stabilizers are in the deployed position; and

FIG. 7 is an exploded view of the layout tool.

Corresponding reference characters indicate corresponding parts throughout the drawings.

### DETAILED DESCRIPTION OF THE INVENTION

The layout tool disclosed herein assists a user in marking up a workpiece (not shown). The workpiece may include a piece of lumber, a board, a panel, a plate or any other suitable item a user may want to mark up. For example, the layout tool disclosed herein may be used to place a cut marking (via a pen or pencil) on a piece of lumber or board indicating where a cut is to be made. The layout tool of the present disclosure is configured as a T-shaped square (also known as a T-square), although the layout tool (e.g., measurement tool) may have other configurations, such a ruler, a triangle square, a L-shaped square, etc., without departing from the scope of the present disclosure. Moreover, it is understood the teachings set forth herein can also be applied to other types of tools.

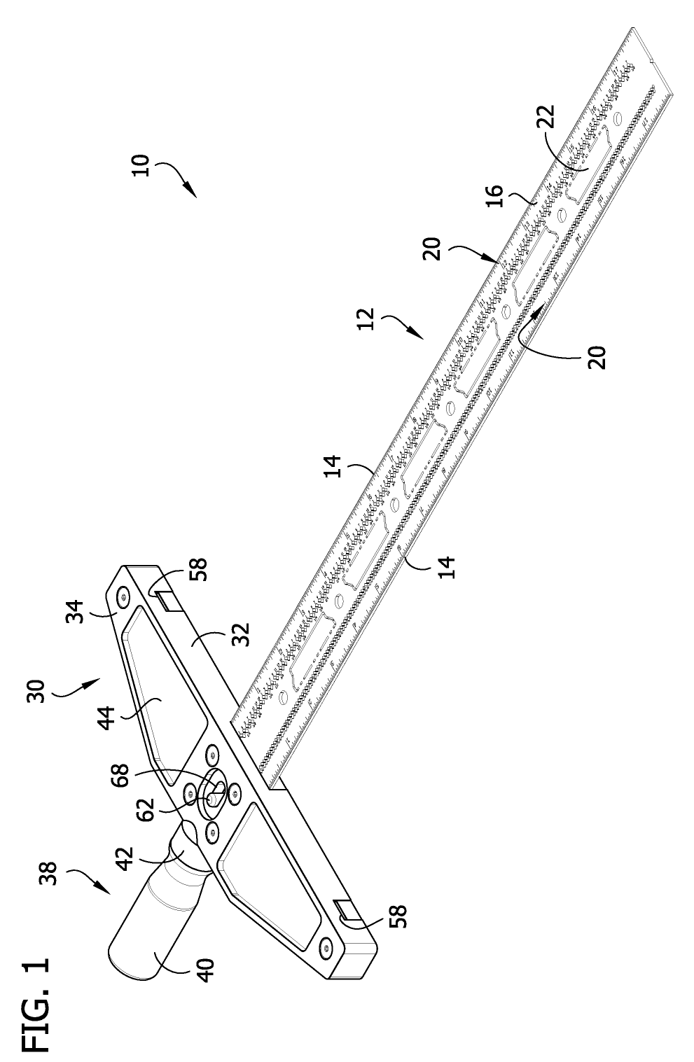

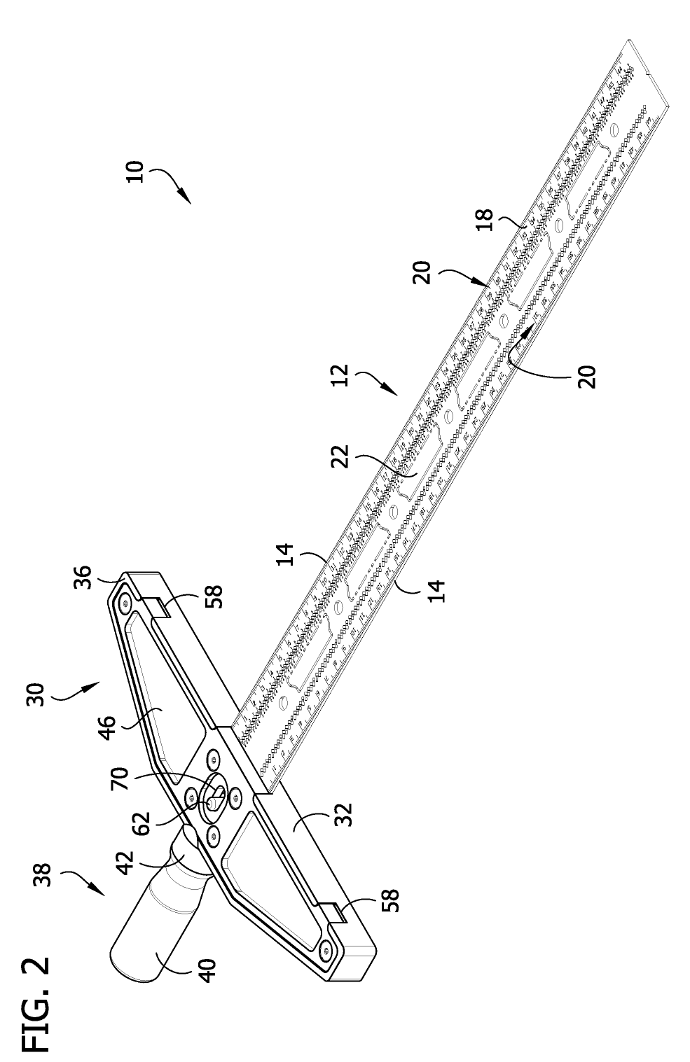

Referring to FIGS. 1 and 2, a layout tool according to one embodiment of the present disclosure is generally indicated by reference numeral 10. In this embodiment, the layout tool 100 comprises a T-square. The layout tool 10 includes a generally flat or planar body 12 (e.g., blade, bar, or ruler). The flat body 12 is elongate. Desirably, the length of the flat body 12 is at least two-times longer than the width of the flat body, more desirably at least three-times longer, more desirably at least four-times longer, more desirably at least five-times longer. In the illustrated embodiment, the flat body 12 has a generally rectangular shape. The flat body 12 includes at least one straight or linear edge 14 (e.g., side edge). In the illustrated embodiment, the flat body 12 includes opposite first and second linear edges 14, extending along the length of the flat body. The two linear edges 14 are generally parallel to one another. Each linear edge 14 extends between opposite ends of the flat body 12. The flat body 12 has a first (e.g., upper) face or surface 16 and a second (e.g., bottom) face or surface 18 opposite the first face. The first and second faces 16, 18 (e.g., first and second flat body faces) are generally flat and planar. The first and second faces 16, 18 extend between the first and second linear edges 14, and the opposite ends of the flat body 12. The first face 16 rests on a surface of the workpiece when the layout tool 10 is used in one orientation (e.g., generally, the orientation shown in FIG. 2) and the second face 18 rests on the surface of the workpiece when the layout tool is used in another orientation (e.g., generally, the orientation shown in FIG. 1). For a workpiece having a flat, upwardly facing surface, such as conventional lumber, the engaging face (16 or 18) has a flush or conformal engagement with the surface of the workpiece.

The layout tool 10 includes locating or measurement indicia 20 adjacent each linear edge 14. The locating indicia 20 can be adjacent one or both linear edges 14. Preferably, the locating indicia 20 comprises a measurement scale such as an English (e.g., inch) measurement scale and/or a metric (e.g., cm) measurement scale, although other types of locating indicia may be used without departing from the scope of the present disclosure. In the illustrated embodiment, the locating indicia 20 is an inch measurement scale (e.g., 0-18 inches). The locating indicia 20 can be included on one or both of the first face 16 and the second face 18. In the illustrated embodiment, the layout tool 10 includes four sets of locating indicia 20, two on the first face 16 adjacent each linear edge 14 and two on the second face 18 adjacent each linear edge. The sets of locating indicia 20 may be in the same or different units (broadly, types of scales). In one embodiment, the locating indicia 20 is formed on the flat body 12 by removing material from the flat body. For example, the locating indicia 20 may be formed by laser-etching, although other ways of forming the locating indicia on the flat body may be used without departing from the scope of the present disclosure.

The flat body 12 can include one or more indicia openings in the flat body 20 aligned with the locating indicia 20 for assisting the user in marking the workpiece. Each indicia opening can correspond to one marking of the locating indicia 20. The user inserts the marking instrument (e.g., writing instrument such as a pen or pencil) through the indicia opening associated with the desired marking of the locating indicia 20 to mark the workpiece at the desired location. Each indicia opening can correspond to more than one marking of the locating indicia 20. In this embodiment, the indicia opening includes notches (e.g., V-notches) associated with each marking to locate the marking instrument. The flat body 12 may also include one or more grips 22 to help inhibit the flat body 12 (broadly, layout tool 10) from moving (e.g., sliding) on the workpiece. The grips 22 may be of any suitable construction. For example, the grips 22 may be of those described in U.S. Patent No. 11,673,420, the entirety of which is hereby incorporated by reference. Other types of grips may be used without departing from the scope of the present disclosure.

In the illustrated embodiment, the flat body 12 is a single, unitary piece of material. For example, the flat body 12 can be made from a single piece of sheet metal or extruded aluminum. In another embodiment, the flat body 12 can be formed from multiple pieces secured together.

The layout tool 10 includes a base or head 30 (e.g., cross-piece). The base 30 is coupled to the flat body 12. The flat body 12 extends from the base 30 (specifically, from a central region of the base). The base 30 includes a base surface 32 (e.g., side base surface). The side base surface 32 is generally flat and planar. The side base surface 32 extends between the opposite ends of the base 30. In use, the side base surface 32 can engage the workpiece. The side base surface 32 engages (e.g., abuts) a different surface (e.g., edge, side surface) of the workpiece than the first and second faces 16, 18 of the flat body 12. The base 30 is thicker than the flat body 12. The side base surface 32 extends above the upper face 16 and below the bottom face 18 of the flat body 12. The flat body 12 extends outward from the base surface 32. A longitudinal axis of the flat body 12 is generally perpendicular to the side base surface 32. In other words, the first and second linear edges 14 are generally perpendicular to the side base surface 32. The base 30 includes a first (e.g., upper) base face or surface 34 and a second (e.g., bottom) base face or surface 36 opposite the first base face. The first and second base faces 34, 36 are generally flat and planar. In the illustrated embodiment, the base 30 includes one or more recesses in each of the first and second base faces 34, 36.

The layout tool 10 can include a handle 38 supported by the base 30. The handle 38 is coupled to the base 30, such as with a threaded stud or fastener (not shown). The handle 38 is attached to the central region of the base 30. In the illustrated embodiment, the handle 38 is arranged opposite the flat body 12 (e.g., disposed on an opposite side of the base from the flat body). In the illustrated embodiment, the longitudinal axes of the handle 38 and flat body 12 are generally co-extensive with one another and pass through the central region of the base 30. The handle 38 includes a gripping portion 40 and a collar 42 disposed between the gripping portion and the base 30. The collar 42 may extend over on or both of the first and second base faces 34, 36. In other embodiments, the collar may not extend over either of the base faces 34, 36. Other configurations of the handle may be used without departing from the scope of the present disclosure. The handle 38 can be omitted from the layout tool 10.

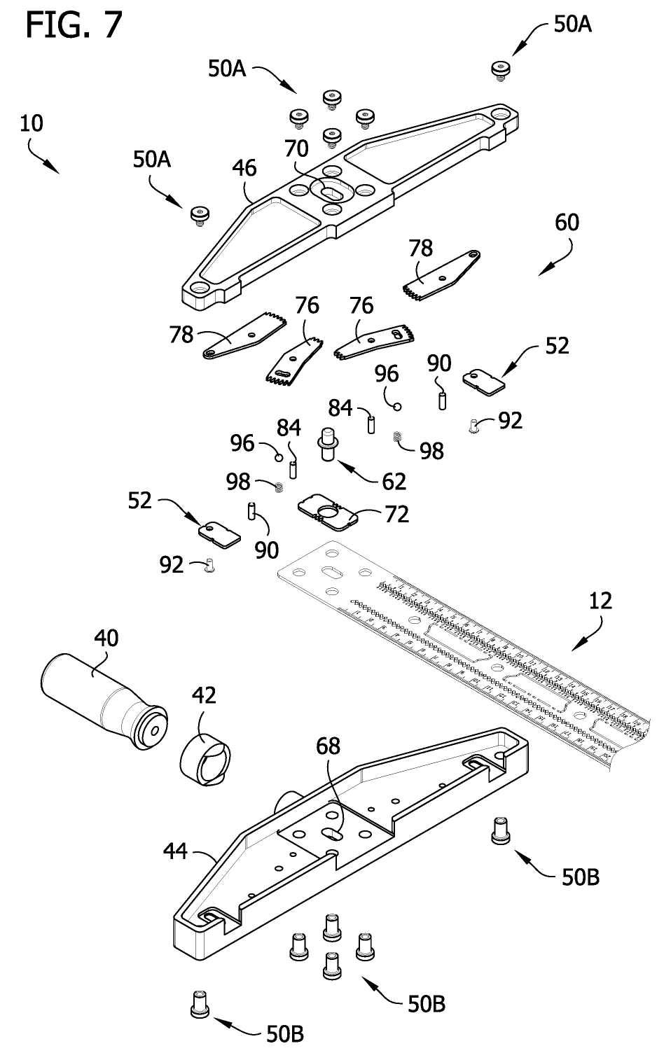

The base 30 includes a first or upper housing 44 and a second or lower housing 46. The base 30 includes an interior 48. The interior 48 is defined by the first and second housings 44, 46. The interior 48 is generally enclosed by the first and second housing 44, 46. As will become apparent, the various components of the layout tool 10 are housed or contained in the interior 48 of the base 30. The upper and lower housings 44, 46 are coupled together. In the illustrated embodiment, the upper and lower housings 44, 46 are coupled together with a plurality of fasteners. The fasteners including externally threaded fasteners 50A that threadably connect to internally threaded fasteners 50B (FIG. 7). A portion of these fasteners 50A-B extend through the flat body 12 to secure the flat body to the base 30. Other ways of connecting the upper and lower housings together may be used without departing from the scope of the present disclosure. It is appreciated that one or both of the upper and lower housings 44, 46 define or form various features of the base 30 described herein (such as the surface 32 and faces 34, 36).

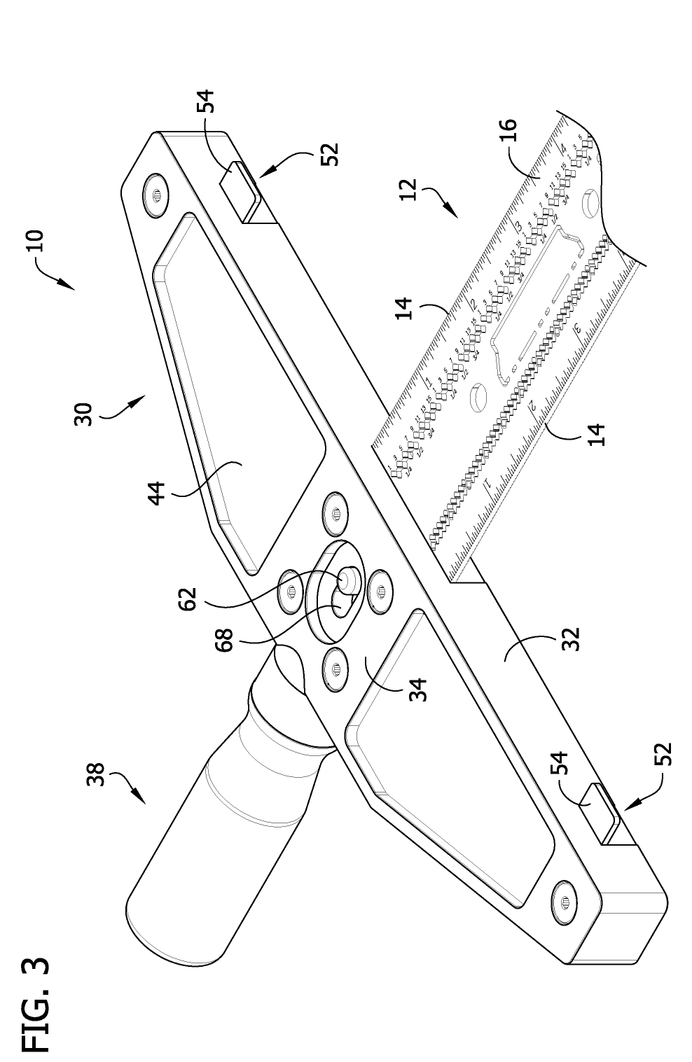

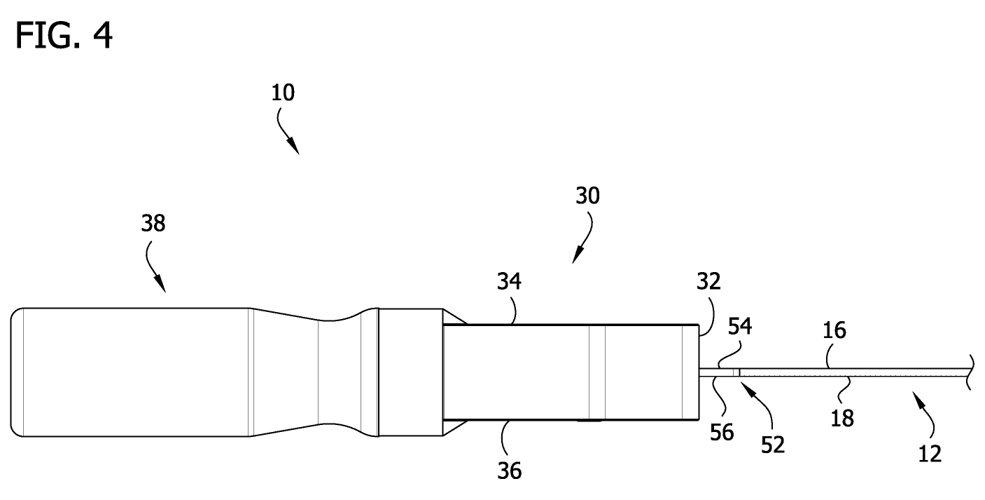

Referring to FIGS. 3-6, the layout tool 10 includes one or more stabilizers or supports 52 (e.g., tabs) supported by the base 30. In the illustrated embodiment, the layout tool 10 includes two (e.g., first and second) stabilizers 52. The two stabilizers 52 are generally identical. Each stabilizer 52 is moveable, relative to the base 30 and the flat body 12, between a first or deployed position (FIGS. 3, 4, and 6) and a second, retracted or stowed position (FIGS. 1, 2, and 5). In each stabilizer’s 52 deployed position, the stabilizer is arranged to engage the workpiece to help support or stabilize (e.g., balance) the layout tool 10 on the workpiece. Specifically, in the deployed position, each stabilizer 52 is arranged to engage the surface of the workpiece when one of the upper or bottom faces 16, 18 of the flat body 12 rests on the surface of the workpiece (e.g., the stabilizers engage the same surface as the flat body). Each stabilizer 52 extends outward from the base 30 when in the first position. Specifically, each stabilizer 52 extends outward from the side base surface 32 when in the first position. Each stabilizer 52 extends in generally the same direction as the flat body 12, from the side base surface 32. Desirably, each stabilizer 52 is arranged to engage the surface of the workpiece regardless of which of the upper or bottom faces 16, 18 rests on the surface of the workpiece. Each stabilizer 52 includes a first (e.g., upper) stabilizer face or surface 54 and a second (e.g., bottom) stabilizer face or surface 56 opposite the first face. The first and second stabilizer faces 54, 56 are generally flat and planar.

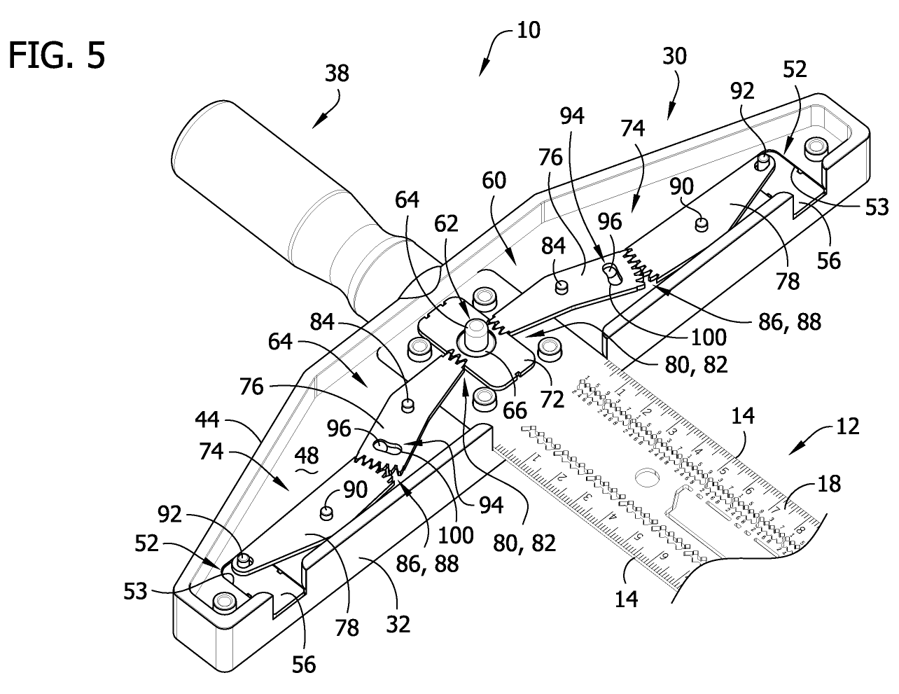

At least one of the stabilizer faces 54, 56 is coplanar with one of the faces 16, 18 of the flat body 12 when in the deployed position. In the illustrated embodiment, in the deployed position (FIG. 5), the upper stabilizer face 54 of each stabilizer 52 is coplanar with the upper face 16 of the flat body 12 and the lower stabilizer face 56 of each stabilizer is coplanar with the bottom face 18 of the flat body. This allows the stabilizers 52 (e.g., either of the stabilizer faces 54, 46 thereof) to lay flat on the surface of the workpiece when the flat body 12 (e.g., either of the faces 16, 18 thereof) lays flat on the surface of the workpiece. Each stabilizer 52 is spaced apart from (e.g., laterally apart from) the flat body 12. In the illustrated embodiment, the first and second stabilizers 52 are disposed on opposite sides of the flat body 12. This arrangement allows the stabilizers 52 to help prevent the layout tool 10 from twisting or rotating generally about the longitudinal axis of the flat body 12 on the workpiece.

In each stabilizer’s 52 retracted position, the stabilizer is arranged to be free of engagement with the workpiece. Specifically, in the retracted position, each stabilizer 52 is arranged to be free of engagement with the surface of the workpiece when either of upper or bottom faces 16, 18 of the flat body 12 rests on the surface of the workpiece. More specifically, in the retracted position, the upper stabilizer face 54 of each stabilizer 52 is arranged to be free of engagement with the surface of the workpiece when the upper face 16 of the flat body 12 is resting on the surface of the workpiece. Similarly, in the retracted position, the lower stabilizer face 56 of each stabilizer 52 is arranged to be free of engagement with the surface of the workpiece when the bottom face 18 of the flat body 12 is resting on the surface of the workpiece. In the retracted position, each stabilizer 52 is retracted into the base 30 (e.g., entirely disposed in the interior 48 of the base). The end of each stabilizer 52 is flush with or reassessed inward of the side base surface 32. In the retracted position, the upper stabilizer face 54 of each stabilizer 52 is still coplanar with the upper face 16 of the flat body 12 and the lower stabilizer face 56 of each stabilizer is still coplanar with the bottom face 18 of the flat body.

The base 30 (specifically, the side base surface 32) includes a stabilizer opening 58 for each stabilizer 52 to move through as the stabilizer moves between the deployed and retracted positions. Each stabilizer 52 extends through their respective stabilizer opening 58 when in the deployed positons. Each stabilizer 52 moves linearly, generally parallel to the longitudinal axis of the flat body 12, between the deployed and retracted positons. The stabilizers 52 can move simultaneously from their respective deployed positions toward their respective retracted positions and from their respective retracted positions toward their respective deployed positions. In another embodiment (not shown), each stabilizer 52 is moveable between their deployed and retracted positions independent of the other stabilizer. The upper housing 44 can include a channel or recess 53 for each stabilizer 52 that receives the stabilizer and guides the movement of the stabilizer between the deployed and retracted positions. The stabilizer opening 58 is at (e.g., defines) one end of the channel 53.

Referring to FIG. 5-7, the layout tool 10 includes a drive assembly 60 to move each of the stabilizers 52 between their respective deployed and retracted positions. The drive assembly 60 moves the first and second stabilizers 52 simultaneously between the deployed and retracted positions. The drive assembly 60 is connected to (e.g., housed by) and supported by the base 30. The drive assembly 60 includes an actuator 62 and a drive train 64. The actuator 62 is operatively coupled to the stabilizers 52 to move the stabilizers between the deployed and retracted positions. The actuator 62 is positioned to be engaged by the user to allow the user to manually move the actuator to move the stabilizers 52 between the deployed and retracted positions. In the illustrated embodiment, the actuator 62 includes a rod or shaft 64 and a flange 66 extending radially outward from the rod 64. Opposite end portions of the rod 64 are exposed to be engaged by the user. The rod 64 extends through an upper elongate slot 68 in the base 30 (e.g., upper housing 44) and a lower elongate slot 70 in the base (e.g., lower housing 46). The upper and lower slots 68, 70 are each linear (e.g., parallel to the longitudinal axis of the flat body 12) with closed ends. Each end portion of the rod 64 is disposed in one of the recesses in the upper or lower base face 34, 36 of the base 30. The user engages one or both of the end portions of the rod 64 to move (e.g., linearly move, slide) the rod along the upper and lower slots 68, 70 to move the stabilizers 52 between the deployed and retracted positions. The actuator 62 is located in the central region of the base 30. Desirably, the actuator 62 does not extend proud of the base 30. For example, the upper base face 34 lies in an upper base plane and the lower base face 36 lies in a lower base plane, desirably the actuator 62 is disposed entirely between the upper and lower base planes. The upper end of the actuator 62 may be flush or coplanar with or disposed at an elevation below the upper base face 34 (e.g., does not extend proud of the upper base plane). The lower end of the actuator may be flush or coplanar with or disposed at an elevation above the bottom base face 36 (e.g., does not extend proud of the lower base plane). This prevents the actuator 62 from inhibiting the base 30 (e.g., upper and bottom base face 34, 36) from lying flat on a surface. Other components of the layout tool 10, such as the fasteners 50A-B, may also be arranged like the actuator 62 to allow the base 30 to lay flat on a surface. In one embodiment, the handle 38 is configured to be entirely disposed between the upper and lower base planes as well. Other configurations of the actuator may be used without departing from the scope of the present disclosure.

The drive train 64 operatively couples the actuator 62 to the stabilizers 52. The drive train 64 includes a slider or slide plate 72 in the interior 48 of the base 30. The slider 72 is directly engaged by the actuator 62 (e.g., the flange 66 thereof). The slider 72 includes an opening the actuator 62 (e.g., the flange 66 thereof) is disposed in. The actuator 62 engages and pushes the slider 72 as the actuator is moved by the user. The slider 72 moves linearly, generally parallel to the longitudinal axis of the flat body 12. The lower housing 46 can include a channel or recess (not shown, similar to channel 53) that receives the slider 72 and guides the movement of the slider. The drive train 64 includes first and second linkages 74, each operatively connecting one of the stabilizers 52 to the slider 72. The linkages 74 are disposed in the interior 48 of the base 30. The first and second linkages 74 are generally identical (e.g., are mirror images of one another. Accordingly, one linkage 74 will now be described with the understanding the description applies to the other linkage as well.

The linkage 74 includes a first link 76 and a second link 78. The first and second links 78 are arranged such that movement of the actuator 62 moves the first and second links to move the stabilizer 52 (corresponding to the linkage 74) between the deployed and retracted positions. The first link 76 is engaged and moved by the slider 72. In the illustrated embodiment, one end of the first link 76 includes gear teeth 80 in mesh engagement with gear teeth 82 of the slider 72. The first link 76 is pivotable or rotatable about a first pin or shaft 84 defining a first axis of rotation. The second link 78 is engaged and moved by the first link 76. In the illustrated embodiment, the opposite end of the first link 76 includes gear teeth 86 in mesh engagement with gear teeth 88 of the second link 78 (at one end thereof). The second link 78 is pivotable or rotatable about a second pin or shaft 90 defining a second axis of rotation spaced from the first axis of rotation. The opposite end of the second link 78 is connected to the stabilizer 52 via a pin or fastener 92. The pin 92 extends through the stabilizer 52 (e.g., a circular opening thereof) and the second link 78 (e.g., a slightly oblong opening or slot thereof, which accommodates the linear movement of the stabilizer relative to the rotational movement of the second link). The base of the channel 53 can include another channel or recess 55 to accommodate the head of the pin 92. The lower housing 46 may include a similar channel or recess (not shown) to accommodate the end of the pin 92. Other configurations of the drive train may be used without departing from the scope of the present disclosure.

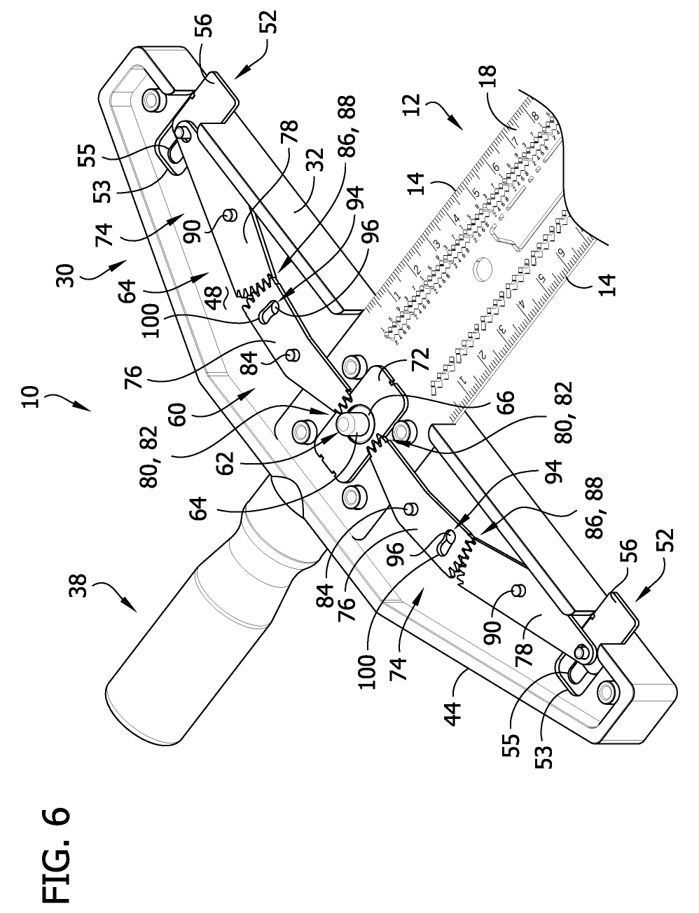

In operation, with reference to FIG. 5 with the stabilizers 52 in their retracted positions, the user pushes the actuator 62 forward, toward the side base surface 32. This moves the slider 72 forward as well, rotating the first and second links 76, 78 in opposite directions. For example, one first link 76 rotates clockwise about the shaft 84 and its corresponding second link 78 rotates counter-clockwise about the shaft 90, and the other first link 76 rotates counter-clockwise about the shaft 84 and the its corresponding other second link 78 rotates clockwise about the shaft 90. This moves the two stabilizers 52 toward their deployed positions. Similarly, with reference to FIG. 6 with the stabilizers 52 in their deployed positions, the user pushes the actuator 62 rearward, toward the handle 38 and away from the side base surface 32. This moves the slide, the first links 76, and the second links 78 in the opposite directions described above in this paragraph, thereby moving the two stabilizers toward their retracted positions.

The layout tool 10 can include one or more retainers 94 for retaining or keeping the stabilizers 52 in at least one of the deployed position or retracted position, desirably both. In the illustrated embodiment, the layout tool 10 includes two retainers 94, one associated with each linkage 74. It is appreciated only one of the illustrated retainers 94 is needed to keep or hold both the stabilizers 52 in both the deployed and retracted positions. In this embodiment, the retainers 94 also keep or hold the actuator 62 in its corresponding first or deployed position and second or retracted position. In the illustrated embodiment, each retainer 94 engages one of the linkages 74, specifically the first link 76, to retain the stabilizers 52. The illustrated retainers 94 each comprise a detent 96 (e.g., ball) biased toward and into engagement with the first link 76 with a spring 98 (FIG. 7). Each first link 76 includes a recess or opening 100 that receives the detent 96. The illustrated opening 100 includes two pocket sections with a narrower neck section therebetween. Each pocket section is associated with the deployed position or the retracted position. The detent 96 moves into a pocket section via the spring 98 when the pocket section is aligned with the detent, thereby holding the stabilizer 52 in the deployed or retracted position associated with that pocket section. In operation, the user applies sufficient manual force to the actuator 62 to overcome the force of the springs 98 and move the detents 96 out of one pocket section (via the narrower neck section) as the first link 76 rotates and then the detent moves into the other pocket section when said other pocket section aligns with the detent. Other retainer configurations can be used without departing from the scope of the present disclosure. For example, the retainer could engage other components such as the slider 72, the actuator 62, and/or the stabilizers 52.

To use the layout tool 10, the user lays the flat body 12 onto a workpiece (e.g., as surface thereof). The user can abut the base 30 (e.g., the side base surface 32) against the edge (e.g., straight or linear edge) of the workpiece. This will orient the flat body 12 (e.g., the linear edges 14 thereof) to be perpendicular to the edge the side base surface 32 is engaged with. The layout tool 10 may be used to mark the workpiece with the stabilizers 52 in the deployed position or retracted position. With the stabilizers 52 in the deployed position, one or both of the stabilizers may also lay on the surface of the workpiece, supporting and balancing the layout tool 10 on the workpiece. Regardless of whether the stabilizers 52 are in the deployed position or retracted position, the stabilizers do not interfere with the abutment of the side base surface 32 against the edge of the workpiece (broadly, positioning the flat body 12 perpendicular to the edge of the workpiece). After the layout tool 10 is positioned on the workpiece, the user utilizes the locating indicia 20 (with or without the indicia openings) along one or both linear edges 14 to mark the workpiece appropriately. The layout tool 10 can be used in other ways without departing from the scope of the present disclosure.

It is appreciated that the person of ordinary skill in the art is readily able to determine the scope of terms of degree such as, but not limited to, “about,” “substantially,” and “generally.” For example, when a term of degree is used in relation to a numeric value (e.g., 90-degrees (e.g., perpendicular), 0-degrees (e.g., parallel), etc.), the person of ordinary skill in the art understands that the term of degree covers an inclusive range of plus or minus 10% (including the exact value) of the numeric value, including any specific value or sub-range within the inclusive range, unless clearly indicated or stated otherwise.

While particular elements, embodiments, and applications of the present disclosure have been shown and described, it is understood that the disclosure is not limited thereto because modifications may be made by those skilled in the art, particularly in light of the foregoing teaching. It is therefore contemplated by the appended claims to cover such modifications and incorporate those features which come within the spirit and scope of the disclosure.

Having described the disclosure in detail, it will be apparent that modifications and variations are possible without departing from the scope of the disclosure defined in the appended claims.

When introducing elements of the present disclosure or the preferred embodiments(s) thereof, the articles "a", "an", "the" and "said" are intended to mean that there are one or more of the elements. The terms "comprising", "including" and "having" are intended to be inclusive and mean that there may be additional elements other than the listed elements.

In view of the above, it will be seen that the several objects of the disclosure are achieved and other advantageous results attained.

As various changes could be made in the above constructions, products, and methods without departing from the scope of the disclosure, it is intended that all matter contained in the above description and shown in the accompanying drawings shall be interpreted as illustrative and not in a limiting sense.

1. A layout tool for use in marking a workpiece, the layout tool comprising:
a generally flat body having a face and a linear edge, the face arranged to rest on a surface of the workpiece;
a base coupled to the flat body; and
a stabilizer supported by the base, the stabilizer being moveable relative to the base between a first position where the stabilizer is arranged to engage the surface of the workpiece when the face of the flat body rests on the surface of the workpiece and a second position.

2. The layout tool of claim 1, wherein the stabilizer is arranged to be free of engagement with the surface of the workpiece when the face of the flat body rests on the surface of the workpiece and the stabilizer is in the second position.

3. The layout tool of claim 1, wherein the stabilizer extends outward from the base when the stabilizer is in the first position, and wherein the stabilizer is retracted in the base when the stabilizer is in the second position.

4. The layout tool of claim 3, wherein the base includes a surface arranged to engage the workpiece, the stabilizer extending outward from the surface of the base when the stabilizer is in the first position.

5. The layout tool of claim 4, wherein the flat body extends outward from the surface of the base.

6. The layout tool of claim 1, wherein the stabilizer includes a face, the face of the stabilizer being coplanar with the face of the flat body when the stabilizer is in the first position.

7. The layout tool of claim 6, wherein the face of the flat body is a first face of the flat body and the face of the stabilizer is a first face of the stabilizer, wherein the flat body includes a second face and the stabilizer includes a second face, the second face of the stabilizer being coplanar with the second face of the flat body when the stabilizer is in the first position.

8. The layout tool of claim 1, wherein the stabilizer is a first stabilizer, wherein the layout tool further comprises a second stabilizer supported by the base, the second stabilizer being moveable relative to the base between a first position where the second stabilizer is arranged to engage the surface of the workpiece when the face of the flat body rests on the surface of the workpiece and a second position.

9. The layout tool of claim 8, wherein the first and second stabilizers are configured to simultaneously move from their respective first positions toward their respective second positions and from their respective second positions toward their respective first positions.

10. The layout tool of claim 8, wherein the first stabilizer includes a face and the second stabilizer includes a face, the faces of the first and second stabilizers being coplanar with the face of the flat body when the first and second stabilizers are in their respective first positions.

11. The layout tool of claim 1, further comprising an actuator operatively coupled to the stabilizer to move the stabilizer between the first and second positions.

12. The layout tool of claim 11, wherein the actuator is configured to move linearly to move the stabilizer between the first and second positions.

13. The layout tool of claim 11, further comprising a drive train operatively coupling the actuator to the stabilizer.

14. The layout tool of claim 13, wherein the drive train includes a first link and a second link, the first and second link arranged such that movement of the actuator moves the first and second links to move the stabilizer between the first and second positions.

15. The layout tool of claim 14, wherein the first and second links each include teeth in mesh engagement with one another.

16. The layout tool of claim 1, wherein the actuator is located in the base and does not extend proud of the base.

17. The layout tool of claim 1, further comprising a retainer configured to keep the stabilizer in at least one of the first position or the second position.

18. The layout tool of claim 1, further comprising a handle supported by the base.

19. The layout tool of claim 1, wherein the flat body includes locating indicia adjacent the linear edge.

20. The layout tool of claim 1, wherein the linear edge is a first linear edge, the flat body including a second linear edge generally parallel to the first linear edge.
